(19) United States
(12) Patent Application Publication
(10) Pub. No.: US 2011/0272916 A1
(43) Pub. Date: Nov. 10, 2011

(54) Connection Arrangement for a Trailer Vehicle and Trailer Vehicle

(76) Inventors: Rainer Risse, Pattensen-Reden (DE); Udo Ronnenberg, Wedemark (DE); Axel Stender, Hameln (DE)

(21) Appl. No.: 13/126,986

(22) PCT Filed: Aug. 1, 2009
(86) PCT No.: PCT/EP2009/005589

§ 371 Date: Jun. 13, 2011

(30) Foreign Application Priority Data
Nov. 3, 2008 (DE) 10 2008 054 365.9

(51) Int. Cl. B60D 1/64

(52) U.S. Cl. 280/420

(57) ABSTRACT

The invention relates to a connection arrangement for a trailer vehicle and to a trailer vehicle. The connection arrangement (1, 1′, 1″) according to the invention comprises at least two connections (2, 3, 4, 5) of the following connections (2, 3, 4, 5) suitable for a connection on the tractor side: a) a first electrical connection (2) for a brake system, b) a second electrical connection (3) for a lighting system, c) a first pneumatic connection (4) for a brake line, d) a second pneumatic connection (5) for a reservoir line, and a housing (6, 6′, 6″), wherein the at least two connections (2, 3, 4, 5) are disposed on the housing (6, 6′, 6″) and/or are formed at least partially by the housing (6, 6′, 6″).

The invention relates to a connection arrangement for a trailer vehicle, in particular for a trailer vehicle for heavy goods vehicles, and to a, trailer vehicle which comprises a connection arrangement.

It is known to provide connections on trailer vehicles, said connections allowing the trailer vehicle to be supplied or allowing various components of the trailer vehicle to be controlled via a towing vehicle. Therefore, for example, a trailer vehicle for a heavy goods vehicle has a first electrical connection for controlling and supplying a trailer vehicle brake system, a second electrical connection for a lighting system of the trailer vehicle, a first pneumatic connection for a brake line, and a second pneumatic connection for a supply line of the trailer vehicle, it being possible for said connections to be connected to connection cables or connection hoses of the towing vehicle which are associated with the respective connection. The electrical connections are usually in the form of a plug receptacle, the pneumatic connections are usually in the form of coupling heads. In order to equip a trailer vehicle with said connections, it is known to mount the connections individually on a metal support, which is part of a chassis of the trailer vehicle, in the end region of the trailer vehicle.

The object of the present invention is to provide a connection arrangement for a trailer vehicle, which connection arrangement allows various different connections to be mounted on a trailer vehicle in a simple manner. A further object of the invention is to provide a trailer vehicle having a connection arrangement of this kind.

These objects are achieved by a connection arrangement and a trailer vehicle as claimed in the independent claims.

The dependent claims relate to advantageous developments.

The connection arrangement, according to the invention, for a trailer vehicle comprises at least two connections of the following connections which are suitable for a towing vehicle-end connection: a) a first electrical connection for a brake system, b) a second electrical connection for a lighting system, c) a first pneumatic connection for a brake line, d) a second pneumatic connection for a supply line, and a housing, wherein the at least two connections are mounted on the housing and/or are at least partially formed by the housing.

On account of a plurality of different connections being arranged on the housing and/or being at least partially formed by the housing, the housing and these connections form a physical unit. Instead of a large number of individual elements, a reduced number of elements or even only a single element can be achieved for mounting on a trailer vehicle. In this way, a plurality of connections of different types can be mounted on a trailer vehicle with little mounting work.

The housing is preferably designed for connections to be mounted using suitable fixing means, such as holes or threads. However, parts or components of the connections, possibly the entire connection, can also be formed by the housing itself, for example integrally formed or injection-molded on the housing. The latter likewise allows production costs to be reduced.

The electrical lines and/or pneumatic lines which are associated with the individual connections are preferably routed from the connections, through the interior of the housing, and then out of the housing via one or more leadthroughs for the purpose of connection to components of the trailer. It is preferred to provide only one single leadthrough through which all the lines are routed. This makes it easier to ensure the leaktightness of the housing, in particular against the ingress of moisture. Furthermore, the complexity of the cabling of the lines in the trailer vehicle can also be reduced.

Instead of a leadthrough, the housing can also have one or more output connections for the trailer vehicle-end connection of the connection arrangement. In this case, it would no longer be necessary to route lines out of the housing. Instead of this, the connection of the trailer vehicle-end components to suitable connection means can be established via electrical and/or pneumatic lines.

The trailer vehicle according to the invention comprises a connection arrangement of this kind. A connection arrangement of this kind is preferably arranged on a support of the trailer vehicle, for example a support of a trailer vehicle chassis, or on an end wall of the trailer vehicle.

The invention will be described in greater detail below with reference to exemplary embodiments which are illustrated by several figures, in which:

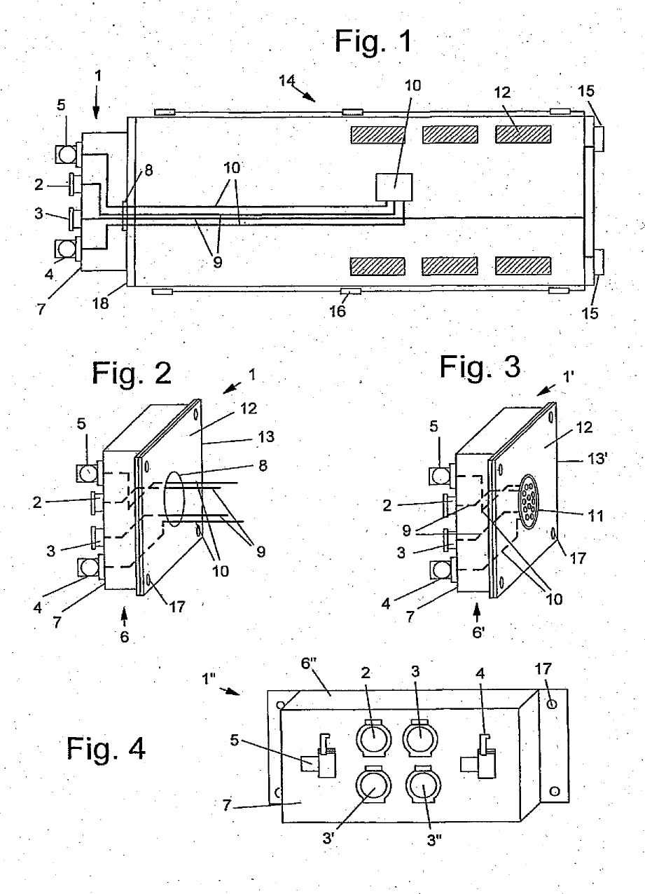

FIG. 1 shows a schematic view of an embodiment of a trailer vehicle according to the invention having a first embodiment of a connection arrangement according to the invention,

FIG. 2 shows the first connection arrangement on its own,

FIG. 3 shows a second embodiment of a connection arrangement, and

FIG. 4 shows a third embodiment of a connection arrangement.

Identical components or components which correspond to one another are provided with the same reference symbols in the figures.

FIG. 1 shows a first embodiment of a trailer vehicle 14 according to the invention which has a connection arrangement 1 according to a first embodiment. The connection arrangement 1 is shown on its own in FIG. 2.

The connection arrangement 1 comprises four connections: a first electrical connection 2 for an electronic brake system 10 of the trailer vehicle 14, a second electrical connection 3 for a lighting system of the trailer vehicle, a first pneumatic connection 4 for a brake line, and a second pneumatic connection 5 for a supply line for controlling and supplying compressed air to the brake system 10. The brake system 10 is known per se and is only symbolically indicated in FIG. 1. The lighting system comprises rear lights 15 and side lights 16. The electrical connections 2, 3 are in the form of plug receptacles according to ISO 7638 or ISO 12098 in this case. The pneumatic connections 4, 5 are in the form of coupling heads. The connections 2, 3, 4 and 4 are provided for the connection of electrical and pneumatic lines of a towing vehicle (not shown) for controlling and supplying components of the trailer vehicle 14, in particular of the brake system 10 and of the lighting system.

The electrical connections 2, 3 and the pneumatic connections 4, 5 are arranged on a housing 6. The housing 6 is a plastic housing in this case. As an alternative, a metal housing, in particular composed of sheet metal, would also be possible. The electrical connections 2, 3 are partially formed by the housing 6, in this case by a plug receptacle housing of the electrical connections 2, 3 which are in the form of plug receptacles being injection-molded onto the housing 6. In order to fix the pneumatic connections 4, 5, threaded pins are integrally formed on the housing 6, the pneumatic connections 4, 5, which are provided with threaded holes which complement said threaded pins, being screwed onto said threaded pins. The housing 6 can also have other fixing means, for example holes or clips, depending on the type of connections which are to be arranged on the housing 6. As in the case of the plug receptacles 2, 3, components can be at least partially formed by the housing 6 in the case of the coupling heads 4, 5 too.

The housing 6 is in the form of a box. The electrical and pneumatic connections 2, 3, 4, 5 are arranged on a towing vehicle-end front face 7 of the housing 6 or are at least partially formed on the towing vehicle-end front face 7 of the housing 6. Furthermore, the housing 6 has a leadthrough 8. The leadthrough 8 is formed on a rear face 12 of the housing which is situated opposite the connections 2, 3, 4, 5. Electrical lines 9 and pneumatic lines 10 which are connected to the connections 2, 3, 4, 5 in the interior of the housing 6 are routed through the leadthrough 8 and out of the housing 6 for the purpose of connection to components of the trailer vehicle 14, in this case the brake system 10 and the lighting system, see FIG. 1. The lines 9, 10 can be formed, for example, by cables, tubes or hoses. The leadthrough 8 is formed through a housing cover 13 of the housing 6. The housing cover 13 and leadthrough 8 are formed in such a way that the interior of the housing 6 is sealed off from the outside, in particular against the ingress of moisture.

The housing 6 has, on its rear face, a plurality of holes 17. The connection arrangement 1 is mounted on the towing vehicle-end front face of the trailer vehicle 14 by means of screw connections on a support 18 of the trailer vehicle via the holes 17. In this case, the support 18 is formed by a metal support of a chassis of the trailer vehicle. As an alternative, the connection arrangement 1 can also be arranged on an end wall of the trailer vehicle.

The trailer vehicle 14 is in the form of a semitrailer for a semitrailer truck with three wheel axles 12. Other types of trailer are also possible.

FIG. 3 shows a second embodiment of a connection arrangement 1′ according to the invention. The second connection arrangement 1′ is largely designed to correspond to the first connection arrangement 1. Therefore, only the differences in relation to the first connection arrangement 1 are discussed in the text which follows.

In contrast to the first connection arrangement 1, the second connection arrangement 1′ has, instead of a leadthrough 8, an output connection 11 which is arranged in the housing cover 13. The connection output 11 is in the form of a plug receptacle 11 in this case, this being symbolically indicated in FIG. 3. A plug receptacle housing of the connection 11 is injection-molded onto the housing cover 13. A plurality of electrical and pneumatic lines 9 and 10 are provided in the interior of the housing 6′, said electrical and pneumatic lines connecting the electrical connections 2, 3 and pneumatic connections 4, 5 to the output connection 11. The connection arrangement 1 can be connected to trailer vehicle-end components, for example to the brake system 10 or to the lights 15, 16 of the lighting system, via trailer vehicle-end lines with suitable complementary connection means, in this case plugs.

The use of an output connection 11 provides the advantage that it is not necessary to route electrical lines 9 and pneumatic lines 10 out of the housing 6′ in uninterrupted form. The connection arrangement 1′ and the trailer vehicle-end cabling can be separated from one another in this way. Furthermore, the connection output 11 can be designed in any desired manner, in particular independently of any standards. In particular, individual lines of the connections 2, 3, 4, 5, for example power supply lines or lines for signal transmission, in particular databus lines, can be combined at the output connection 11, for example by adapters which are preferably suitably arranged in the housing 6′. The trailer vehicle-end cabling, for example, can be reduced as a result.

As an alternative, it is also possible, in particular, to provide a plurality of leadthroughs 8 or a plurality of output connections 11, or to provide leadthroughs 8 and output connections 11 together in one connection arrangement.

FIG. 4 shows a third embodiment of a connection arrangement 1″ according to the invention. In contrast to the first connection arrangement 1, the third connection arrangement 1″ has two further electrical connections 3′, 3″. In accordance with the electrical connection 3, the connections 3′, 3″ are in the form of plug receptacles, wherein the plug receptacle housing is injection-molded onto a housing 6″ of the connection arrangement 1″. The connections 3′, 3″ are connections for a lighting system of a trailer vehicle, in accordance with the electrical connection 3. However, in comparison to the electrical connection 3, the electrical connections 3′, 3″ are designed using other standards and allow the connection of towing vehicle-end lines which have only these standards. The trailer vehicle-end electrical lines which depart from the connections 3, 3′, 3″ can be combined, in particular within the housing 6″.

1. A connection arrangement (1, 1′, 1″) for a trailer vehicle (14), comprising at least two connections (2, 3, 4, 5) of the following connections (2, 3, 4, 5) which are suitable for a towing vehicle-end connection: a) a first electrical connection (2) for a brake system, b) a second electrical connection (3) for a lighting system, c) a first pneumatic connection (4) for a brake line, d) a second pneumatic connection (5) for a supply line, and a housing (6, 6′, 6″), wherein the at least two connections (2, 3, 4, 5) are arranged on the housing (6, 6′, 6″) and/or are at least partially formed by the housing (6, 6′, 6″).

2. The arrangement as claimed in claim 1, wherein the connections (2, 3, 4, 5) are jointly arranged on a towing vehicle-end front face (7) of the housing (6, 6′, 6″) and/or are at least partially formed on the towing vehicle-end front face (7) of the housing (6, 6′, 6″).

3. The arrangement as claimed in either of the preceding claims, wherein the housing (6) has one or more leadthroughs (8) for routing electrical lines (9) or pneumatic lines (10).

4. The arrangement as claimed in claim 3, wherein one or more pneumatic lines (10) and/or electrical lines (9) are routed through one leadthrough (8).

5. The arrangement as claimed in one of the preceding claims, wherein the housing (6′) has one or more output connections (11) for the trailer vehicle-end connection of the connection arrangement (1′).

6. The arrangement as claimed in one of the preceding claims, wherein the at least one leadthrough (8) or the at least one output connection (11) is arranged on a rear face (12) of the housing (6, 6′) which is situated opposite the connections (2, 3, 4, 5) and/or is at least partially formed by said rear face.

7. The arrangement as claimed in one of the preceding claims, wherein the at least one leadthrough (8) or the at least one output connection (11) is arranged on a housing cover (13, 13′) of the housing (6, 6′) and/or is at least partially formed by said housing cover.

8. A trailer vehicle (14), comprising a connection arrangement (1) as claimed in one of the preceding claims.

9. The trailer vehicle as claimed in claim 8, comprising a support (18) on which the connection arrangement (1) is arranged.
